(19) United States
(12) Patent Application Publication
(10) Pub. No.: US 2024/0102752 A1
(43) Pub. Date: Mar. 28, 2024

(54) METHODS FOR MANUFACTURING A COLD-FORMED, ONE-PIECE, FLEXIBLE, PARALLEL-CONNECTION RADIATOR OR HEAT SINK

(71) Applicant: Elven Technologies, Inc., Rancho Cordova, CA (US)

(72) Inventors: Vamekh KHERKHEULIDZE, Tbilisi (GE); Giorgi GABARASHVILI, Ksovrisi (GE); Alexandr CHUBINIDZE, Tbilisi (GE); Bela BUTSKHRIKIDZE, Aspindza (GE); Farid ISMAYILZADA, Rancho Cordova, CA (US)

(21) Appl. No.: 18/372,211

(22) Filed: Sep. 25, 2023

Related U.S. Application Data
(60) Provisional application No. 63/410,135, filed on Sep. 26, 2022.

(51) Int. Cl. F28F 21/06; B29D 22/00

(52) U.S. Cl. CPC F28F 21/062; B29D 22/00; B29K 2083/00

(57) ABSTRACT

Methods for manufacturing a cold-formed, one-piece, flexible, parallel-connection radiator or heat sink are disclosed. An example embodiment includes: preparing a radiator matrix assembly using a parts fabrication process; preparing a lumen matrix component using the parts fabrication process; attaching the lumen matrix component to the radiator matrix assembly to create an assembled radiator matrix with molding space; injecting liquid silicone into the assembled radiator matrix and allowing the liquid silicone to cure; opening the assembled radiator matrix to expose a silicone radiator; and washing the inside of the silicone radiator to disintegrate water-soluble material out of the inside of the silicone radiator, thereby producing a cold-formed, one-piece, flexible, parallel-connection silicone radiator or heat sink.

### PRIORITY PATENT APPLICATION

This non-provisional patent application draws priority from U.S. provisional patent application Ser. No. 63/410,135; filed Sep. 26, 2022. The entire disclosure of the referenced patent application is considered part of the disclosure of the present application and is hereby incorporated by reference herein in its entirety.

### TECHNICAL FIELD

This patent application relates to radiators, heat sinks, and related equipment according to example embodiments, and more specifically to methods for manufacturing a cold-formed, one-piece, flexible, parallel-connection radiator or heat sink.

### COPYRIGHT

A portion of the disclosure in this patent document contains material that is subject to copyright protection. The copyright owner has no objection to the facsimile reproduction of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2021-2023 Elven Technologies, Inc., All Rights Reserved.

### BACKGROUND

Radiators and/or heat sinks are used in many types of industrial equipment and other applications to dissipate the excess heat from their heat-generating parts to an ambient level. A heat sink's thermal performance is affected by many factors including, material types, orientation, shape, perforation, slot, interruption, space between fins, and the arrangement of heat dissipation surfaces relative to free and forced convection conditions. In the last few years, efforts in manufacturing electronic or mechanical devices with less weight, space, and lower cost have been spent. However, cost effective heat dissipation from radiators and heat sinks continues to be a big problem, which many researchers are trying to solve. Moreover, comfortable, effective, and readily manufacturable wearable radiators and heat sinks are also a problem researchers are trying to solve.

### SUMMARY

The example embodiments of the disclosed solutions relate to methods for manufacturing a cold-formed, one-piece, flexible, parallel-connection radiator or heat sink. In particular, the example embodiments relate to creating a manufacturing methodology for fabricating a one-piece, flexible, parallel-connection radiator for wearable applications, like wearable cooling/heating systems or other liquid/air distribution systems. In these applications, flexibility and stretchability are crucial features for comfortable and efficient garment wear. The disclosed methods can be used for liquid/air distribution in multiple industries, as three-dimensional (3D) radiators can also be built by the disclosed methods. The example embodiments of the methods disclosed herein provide the capability of building 3D-shaped, complex radiators for applications in many different industries. Details of example embodiments of the disclosed methods for manufacturing a cold-formed, one-piece, flexible, parallel-connection radiator or heat sink are provided below.

### BRIEF DESCRIPTION OF THE DRAWINGS

The various embodiments are illustrated by way of example, and not by way of limitation, in the figures of the accompanying drawings in which:

FIGS. 1 and 2 illustrate an example embodiment of a Radiator Matrix Component A;

FIGS. 3 and 4 illustrate an example embodiment of a Radiator Matrix Component B;

FIGS. 5 and 6 illustrate an example embodiment of a Lumen Matrix Component;

FIGS. 7 and 8 illustrate an example embodiment of manufacturing method steps for the preparation of the Lumen Matrix Component;

FIGS. 9 through 12 illustrate an example embodiment of manufacturing method steps for the preparation of the Radiator Matrix Assembly;

FIGS. 13 through 16 illustrate an example embodiment of manufacturing method steps for Radiator molding;

FIGS. 17 through 20 illustrate an example embodiment of manufacturing method steps for washing the Radiator;

FIG. 21 depicts the arrangement of four flexible radiators into a simple system, as well as the direction of the cooling fluid flow;

FIG. 22 depicts the arrangement of two flexible radiators in a cylindrical configuration as well as the direction of the cooling fluid flow, the configuration useful for covering limbs and easy flexibility in hinge-type of joints;

FIGS. 23 and 24 depict the possible arrangement of eight flexible radiators to create a cooling vest and cover the torso, as well as the direction of the cooling fluid flow; and

FIG. 25 illustrates a process flow diagram that shows an example embodiment of methods as described herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, methods for manufacturing a cold-formed, one-piece, flexible, parallel-connection radiator or heat sink are disclosed. Details of the components and manufacturing processes used in the example embodiments of the disclosed methods for manufacturing a cold-formed, one-piece, flexible, parallel-connection radiator or heat sink are provided below.

As disclosed herein, the references to specific materials, various acronyms, and abbreviations are defined, explained, and detailed as follows:
a. BVOH—Butenediol Vinyl Alcohol Co-polymer
b. PVA—Polyvinyl Alcohol
c. PLA—Polylactic acid

### Components of the Example Embodiments

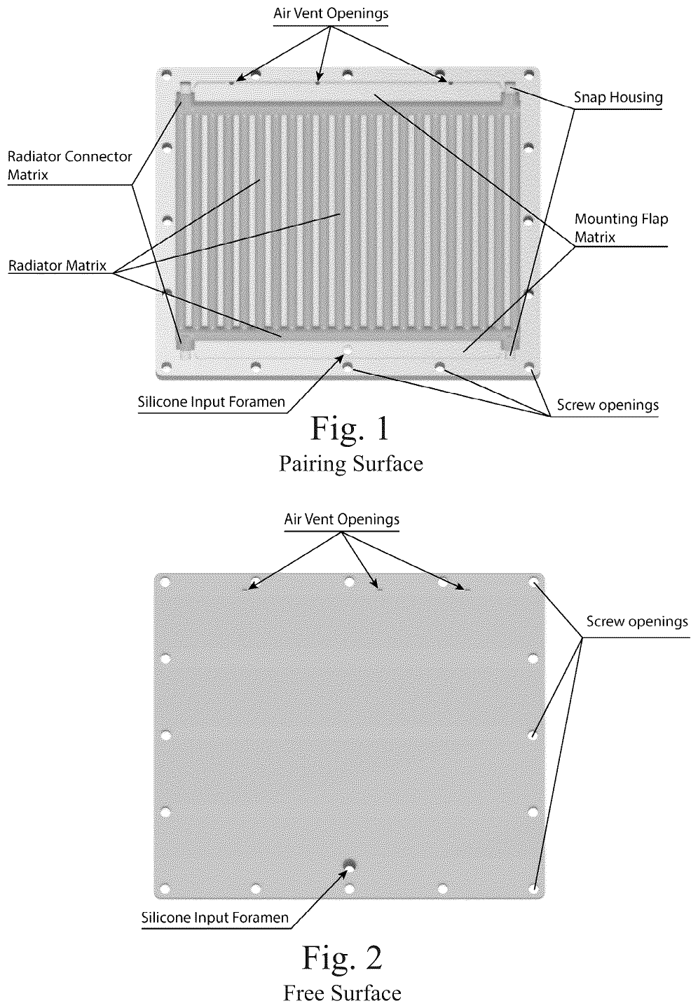

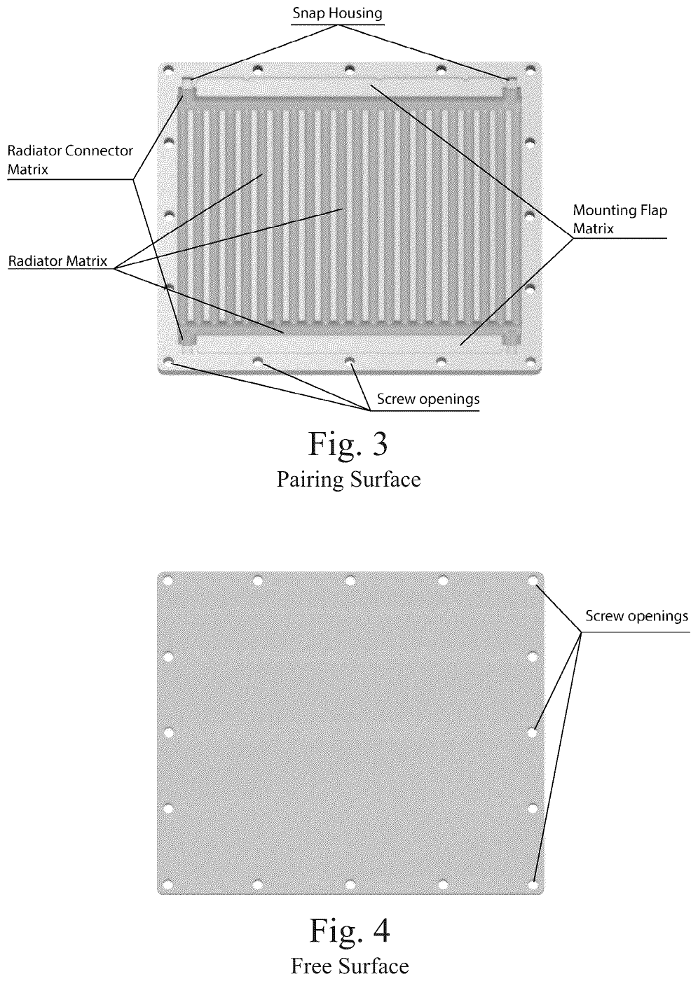

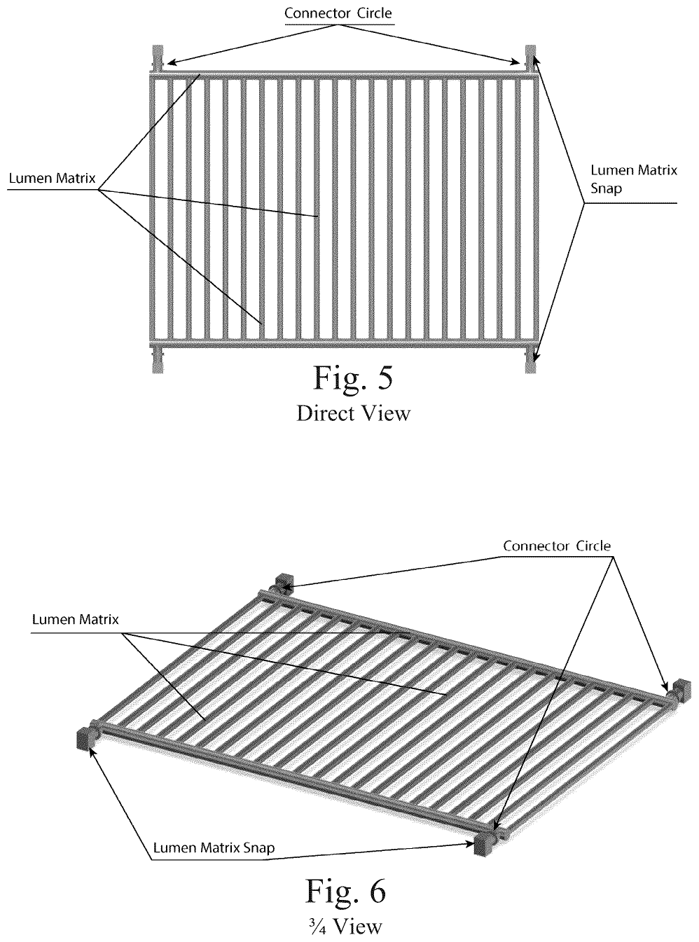

1. Radiator Matrix Component A (See FIGS. 1 and 2)—a hard matter (e.g., plastic, metal, etc.) cut at the center diameter of radiator lines. Features include:
   a. Radiator matrix—determines the outer walls of the silicon radiator (See FIG. 1);
   b. Radiator Connector Matrix—determines the outer wall of the thicker part of the silicon radiator which is designed and used to receive connectors. This is an optional feature, which can be added for ease of connectivity to connectors or other similar radiators. This optional feature is described in more detail below (See FIG. 1);
   c. Snap housing—receives Lumen Matrix Snap. This is an optional feature, which can be added for ease of securing and alignment of the Lumen Matrix Component to the Radiator Matrix Component A. This optional feature is described in more detail below (See FIG. 1). This connection component serves to attach the Lumen Matrix Component to the Radiator Matrix Component A;
   d. Mounting Flap Matrix—determines the shape of Silicon Radiator Mounting Flap, used to mount Silicon Radiator on fabrics or other surfaces. This is an optional feature, which can be used for creating a Mounting Flap (See FIG. 1);
   e. Silicon Input Foramen—angled foramen at the bottom side of the Radiator Matrix Component A, used for filling assembled matrix with liquid silicone (See FIGS. 1 and 2);
   f. Screw Openings—used for tightening screws during the final matrix assembly and alignment process. This is an optional feature, as the function of alignment and securing of matrices can be done in different ways (See FIGS. 1 and 2);
   g. Air Vent Openings—openings at the top side of the Radiator Matrix Component A, let air escape freely during filling of the assembled matrix with liquid silicone, preventing formation of bubbles in the silicone radiator mold (See FIGS. 1 and 2).
2. Radiator Matrix Component B (See FIGS. 3 and 4)—a hard matter (e.g., plastic, metal, etc.) cut at the center diameter of radiator lines. Features include:
   a. Radiator matrix—determines the outer walls of the silicon radiator (See FIG. 3);
   b. Radiator connector matrix—determines the outer wall of the thicker part of the silicon radiator which is designed and used to receive connectors. This is an optional feature, which can be added for ease of connectivity to connectors or other similar radiators. This optional feature is described in more detail below (See FIG. 3);
   c. Snap housing—receives Lumen Matrix Snap. This is an optional feature, which can be added for ease of securing and alignment of the Lumen Matrix Component to the Radiator Matrix Component B. This optional feature is described in more detail below (See FIG. 3);
   d. Mounting Flap Matrix—determines the shape of Silicon Radiator Mounting Flap, used to mount Silicon Radiator on fabrics or other surfaces. This is an optional feature, which can be added for creating a Mounting Flap (See FIG. 3);
   e. Screw Openings—used for tightening screws during the final matrix assembly and alignment process. This is an optional feature, as the function of alignment and securing of matrices can be done in different ways (See FIGS. 3 and 4).
3. Lumen Matrix Component (See FIGS. 5 and 6)—a water soluble hard material used to determine the inner surface (i.e., the lumen) of the Silicone Radiator: Features include:
   a. Lumen Matrix—determines the inner walls (i.e., the lumen) of the Silicon Radiator (See FIGS. 5 and 6);
   b. Connector Circle—determines the shape of circular indent in the internal wall, at the thicker part of the Silicon Radiator designed and used to receive connectors. This is an optional feature, as the connections to the radiator can be achieved in different ways (See FIGS. 5 and 6);
   c. Lumen Matrix Snap—Square shaped, used to firmly secure four angles of the Lumen Matrix Component inside Radiator Matrix Components A and B. Snaps do not participate in creation of the mold, and are removed after curing. This is an optional feature, as the function of alignment and securing of the Lumen Matrix Component to the Radiator Matrix Components 1 and 2 can be achieved in different ways. This optional feature is described in more detail below (See FIGS. 5 and 6).

### Manufacturing Methods for the Example Embodiments

### Preparation of Lumen Matrix Component:

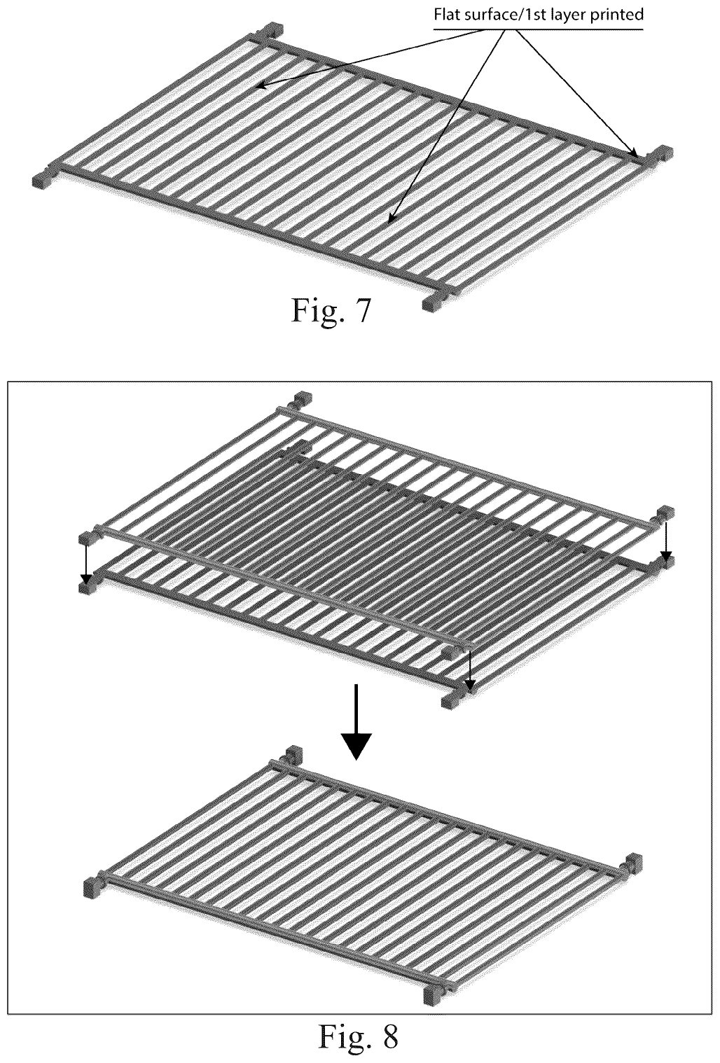

1. The Lumen Matrix 3D model is divided along the transverse plane into two mirroring parts for easier printing on a layer deposition 3D printer (Usage of Stereolithography 3D printer eliminates this step)(See FIG. 7);
2. Each part is printed on a 3D printer using water-soluble/support materials (ex. BVOH, PVA, etc.) (See FIG. 7). Alternatively, parts can be fabricated using a 3D printing process, a mold preparation process, milling, or other type of parts fabrication process.
3. Two mirroring parts are joined/“glued” together by spreading several drops of water along the flat surface (first layer printed by 3D printer) of both parts and gently clamping them together for 15-20 minutes. (See FIG. 8).

### Radiator Matrix Assembly:

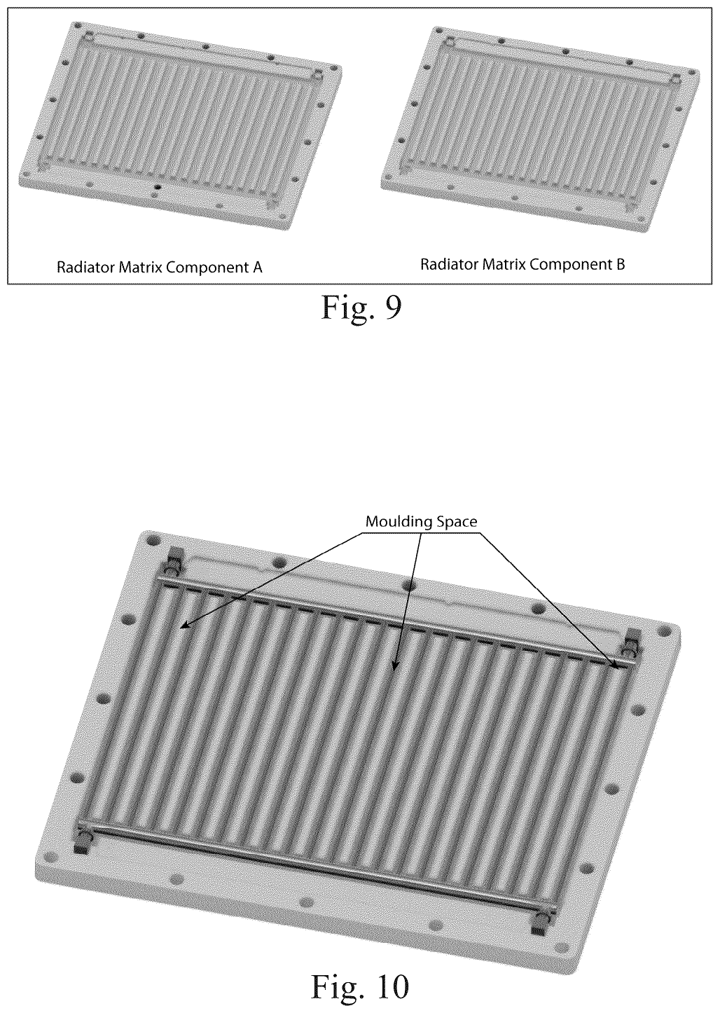

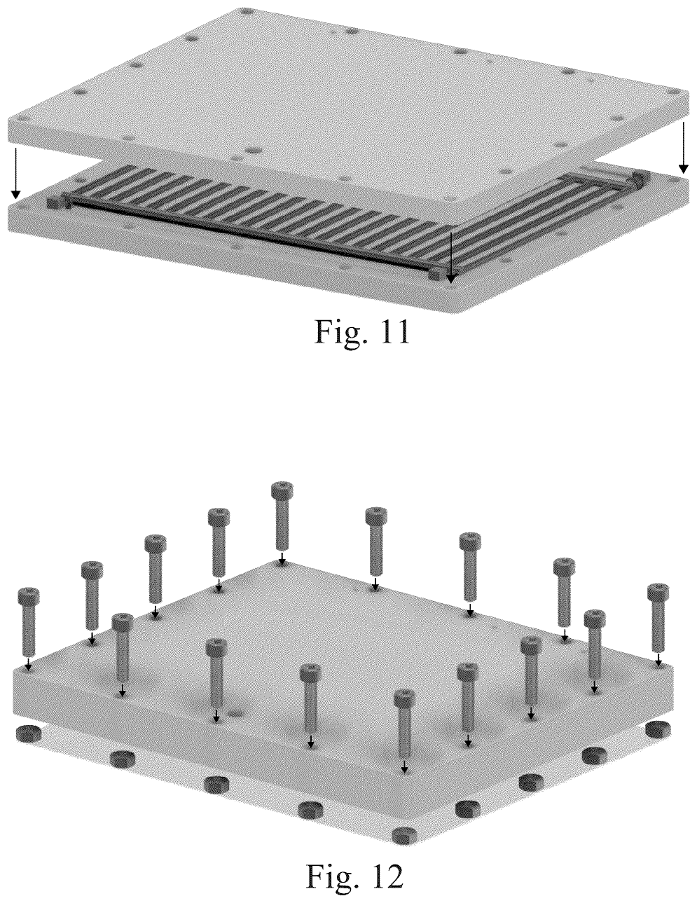

4. Radiator Matrix Components A and B are printed on a layer deposition 3D printer (using PLA printing material) and used for Radiator molding. Radiator Matrix Components A and B can be manufactured from different materials (e.g., plastic, metal, etc.) by different means, like molding, milling, etc. (See FIG. 9).
5. Lumen Matrix is inserted into the one of the Radiator Matrix Components, securely snapping the Lumen Matrix Snaps in their designated spots (See FIG. 10).
6. There is empty space (Molding Space) created between the internal wall of the functional surfaces of Radiator Matrix Components and the external wall of Lumen Matrix Component, where the liquid silicone will be later injected (See FIG. 10).
7. Second Radiator Matrix Component is attached to the free side of Lumen Matrix, securely snapping the Lumen Matrix Snaps in their designated spots (See FIG. 11).
8. Screws are inserted into the designated spots in the Radiator Matrices and secured by corresponding nuts (See FIG. 12).

### Radiator Molding:

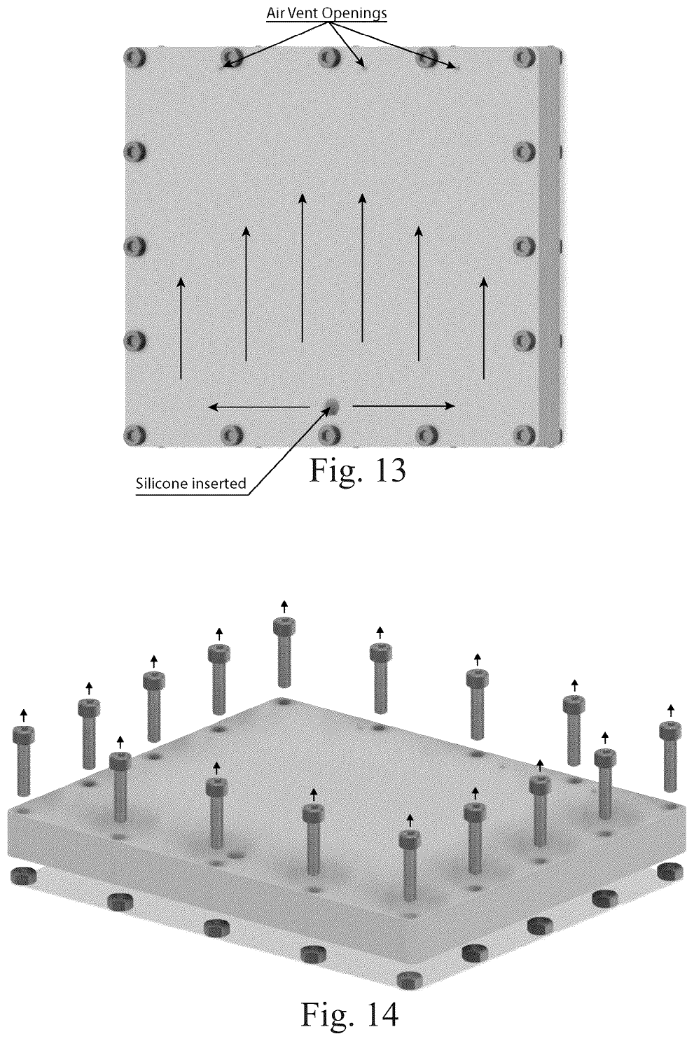

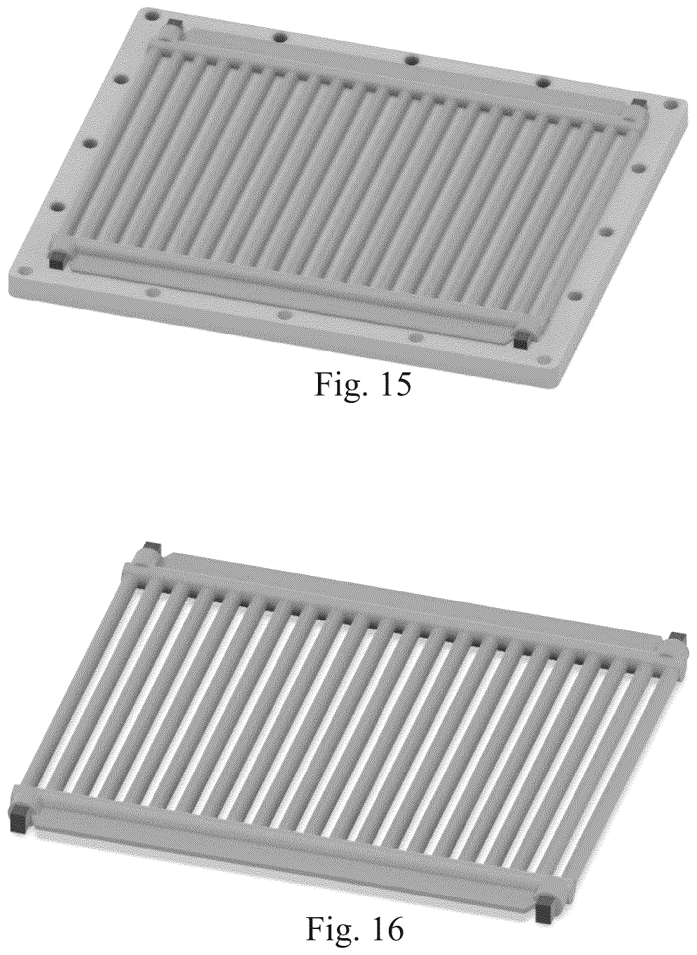

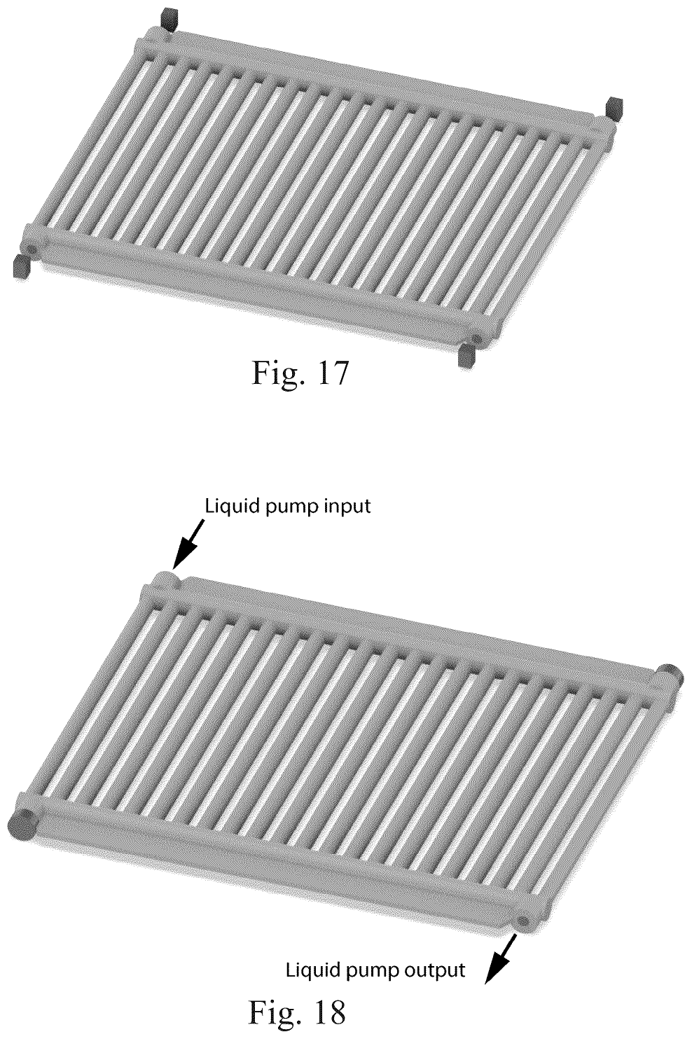

9. A and B parts of the liquid, cold-prepared silicone are mixed according to the instructions. The mixture is placed in the vacuum chamber under maximum vacuum for a pre-determined length of time (e.g., per instructions or dependent on the type of silicone) to evacuate all the air bubbles dissolved in the silicone.
10. Mixed and vacuumed liquid silicone is inserted in the Silicon Input Foramen of the Assembled Radiator Matrix, filling the complete matrix system from down to up, eliminating the air bubbles through the Air Vent Openings by liquid silicone pushing the air bubbles upwards (See FIG. 13).
11. Silicone is left to cure according to specific curing times of the silicone being used.
12. Assembled Radiator matrix is opened by unscrewing the bolts and the Silicone Radiator with the lumen filled with the Lumen Matrix Component emerges (See FIGS. 14 through 16).

### Washing the Radiator:

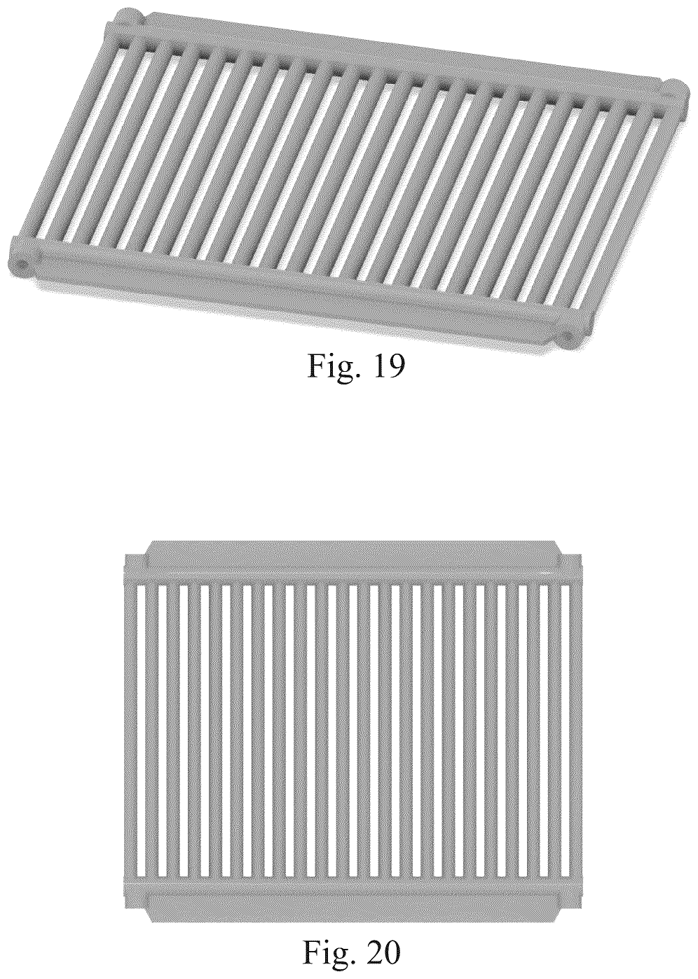

13. Matrix Lumen Snaps are cut and trimmed (See FIG. 17).
14. Two diagonally placed exits are clamped. The other two, unclamped diagonally placed exits are connected to a liquid pump (input and output) that pushes water inside the lumina of the radiator, slowly disintegrating and washing the water-soluble material out of the radiator. The washing time depends on the shape and size of the lumina of the radiator, type of water-soluble material used, as well as individual channels (See FIG. 18).
15. After the washing cycle is complete, the radiator is disconnected from the washing pump and a one-piece, flexible, parallel-connection radiator emerges (See FIGS. 19 and 20).

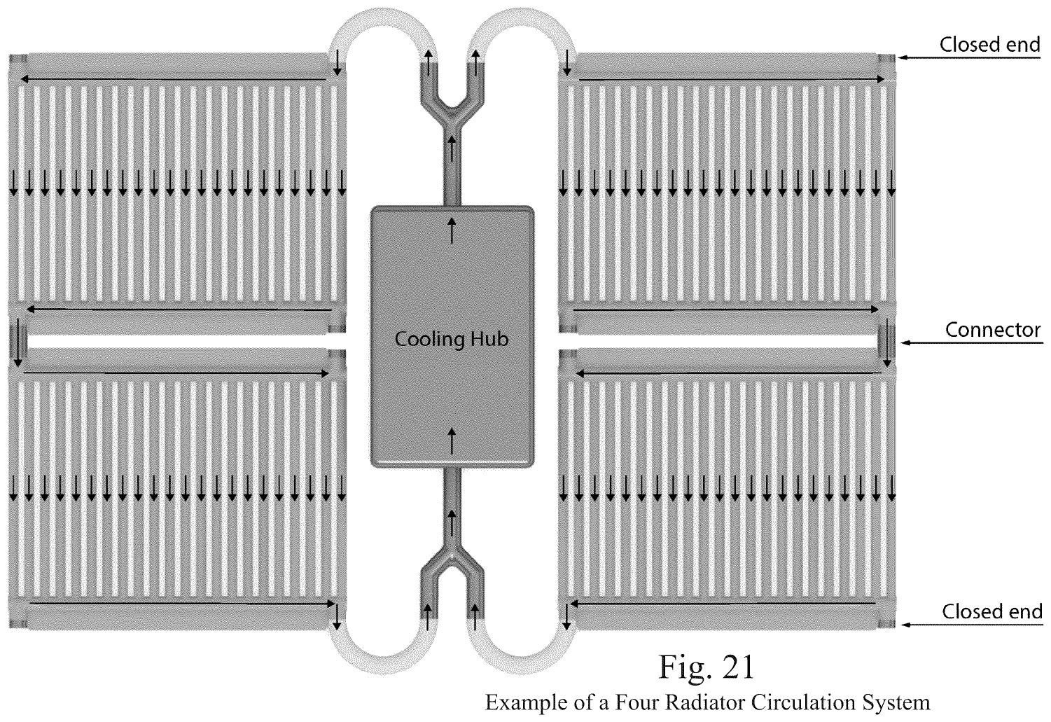

FIG. 21 depicts the arrangement of four flexible radiators into a four radiator circulation system, as well as the connections with a cooling hub and the direction of the cooling fluid flow.

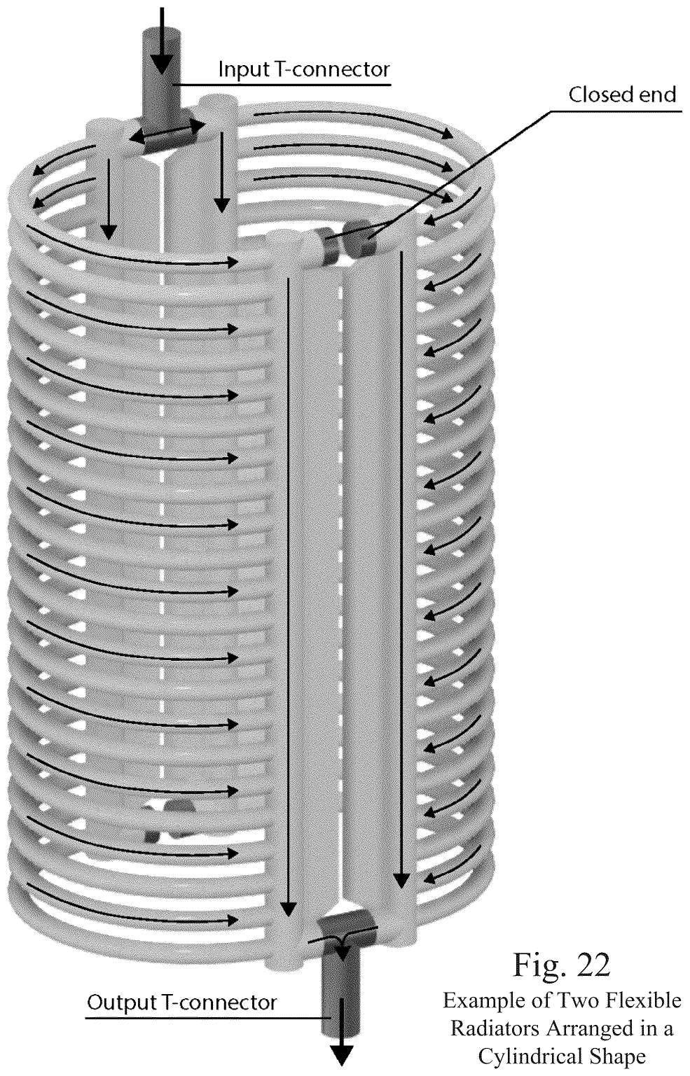

FIG. 22 depicts the arrangement of two flexible radiators in a cylindrical configuration as well as the direction of the cooling fluid flow, the configuration useful for covering limbs of a human and easy flexibility in hinge-type of joints. The example embodiment shows input and out T-connectors for the transfer of the cooling fluid.

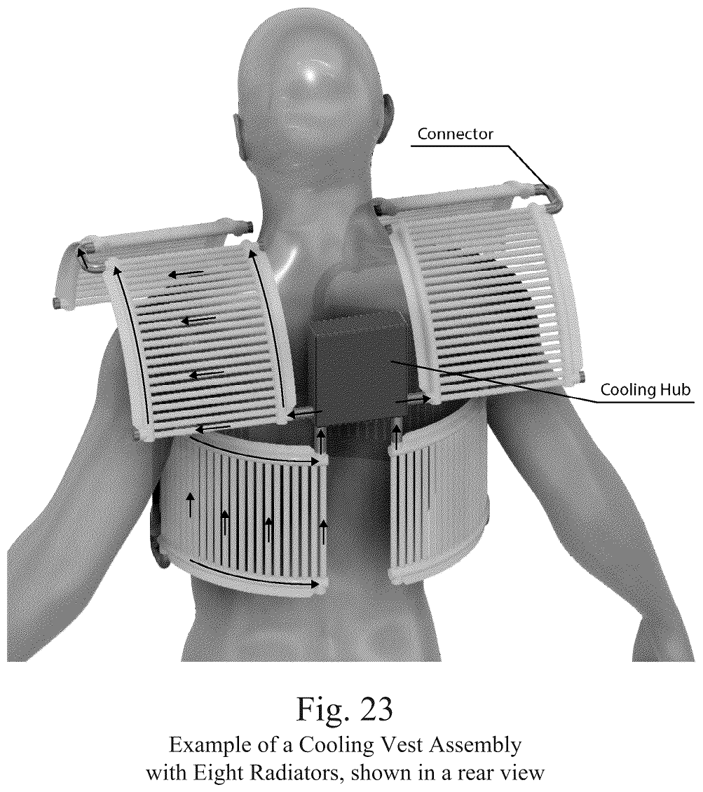

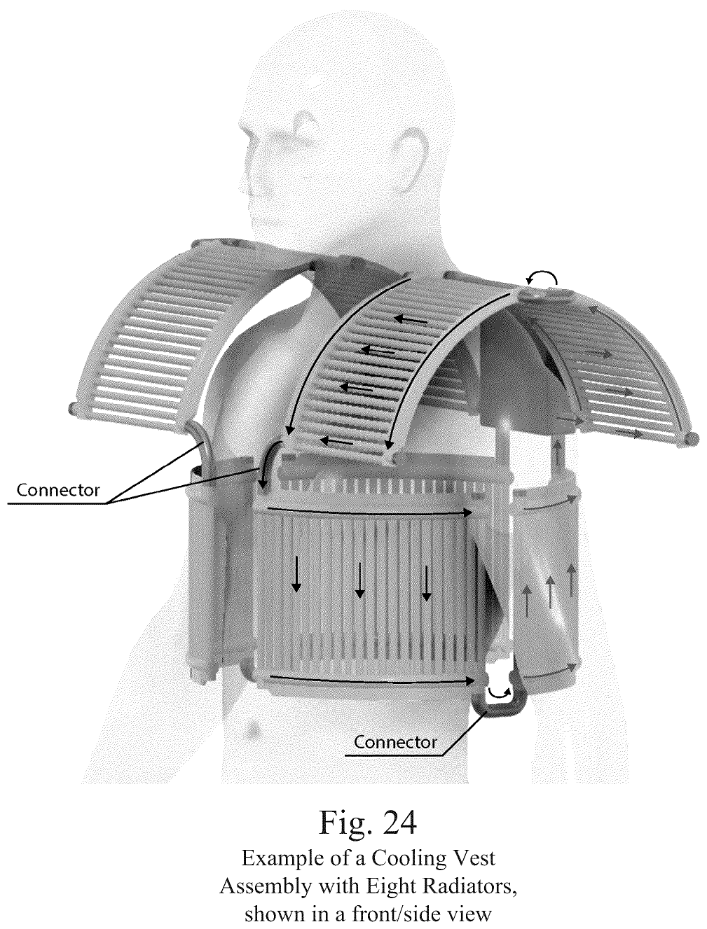

FIGS. 23 and 24 depict an example arrangement of eight flexible radiators to create a cooling vest assembly to cover the torso of a human, as well as the direction of the cooling fluid flow. The example embodiment also shows the connections with a cooling hub and cooling fluid transfer connectors between each of the flexible radiators of the example arrangement.

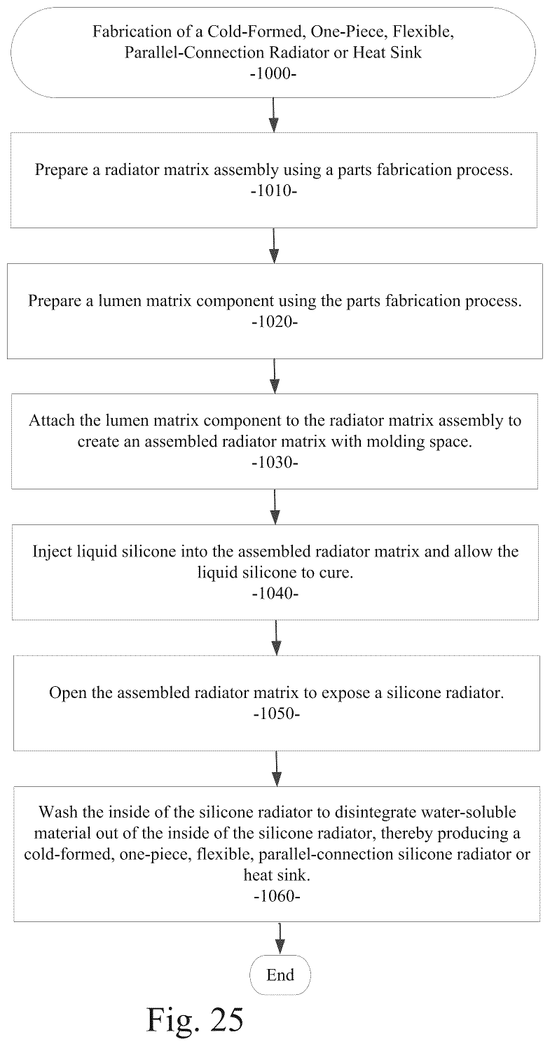

FIG. 25 illustrates a process flow diagram that shows an example embodiment of methods as described herein. Referring to FIG. 25, a method 1000 for fabricating a cold-formed, one-piece, flexible, parallel-connection radiator or heat sink according to an example embodiment includes: preparing a radiator matrix assembly using a parts fabrication process (operation block 1010); preparing a lumen matrix component using the parts fabrication process (operation block 1020); attaching the lumen matrix component to the radiator matrix assembly to create an assembled radiator matrix with molding space (operation block 1030); injecting liquid silicone into the assembled radiator matrix and allowing the liquid silicone to cure (operation block 1040); opening the assembled radiator matrix to expose a silicone radiator (operation block 1050); and washing the inside of the silicone radiator to disintegrate water-soluble material out of the inside of the silicone radiator, thereby producing a cold-formed, one-piece, flexible, parallel-connection silicone radiator or heat sink (operation block 1060).

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, methods for manufacturing a cold-formed, one-piece, flexible, parallel-connection radiator or heat sink are disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. A method for fabricating a cold-formed, one-piece, flexible, parallel-connection radiator or heat sink, the method comprising:
preparing a radiator matrix assembly using a parts fabrication process;
preparing a lumen matrix component using the parts fabrication process;
attaching the lumen matrix component to the radiator matrix assembly to create an assembled radiator matrix with molding space;
injecting liquid silicone into the assembled radiator matrix and allowing the liquid silicone to cure;
opening the assembled radiator matrix to expose a silicone radiator; and
washing the inside of the silicone radiator to disintegrate water-soluble material out of the inside of the silicone radiator, thereby producing a cold-formed, one-piece, flexible, parallel-connection silicone radiator or heat sink.

2. The method of claim 1 wherein the parts fabrication process is a process selected from a group consisting of: a three-dimensional (3D) printing process, a mold preparation process, and a milling process.

3. The method of claim 1 further including providing a liquid pump input and a liquid pump output on the silicone radiator.

4. The method of claim 1 further including providing air vent openings in the assembled radiator matrix to remove air bubbles.

5. The method of claim 1 further including connecting the silicone radiator to a cooling hub.

6. The method of claim 1 further including connecting a plurality of silicone radiators together and configured to enable cooling fluid to flow between the connected silicone radiators.

7. The method of claim 6 further including arranging the connected silicone radiators in a cylindrical shape.

8. The method of claim 1 wherein the lumen matrix component is prepared using water-soluble materials.

9. The method of claim 6 further including arranging the connected silicone radiators in a cooling vest assembly.

10. The method of claim 9 further including connecting at least one of the connected silicone radiators to a cooling hub.

11. A cold-formed, one-piece, flexible, parallel-connection radiator or heat sink fabrication apparatus comprising:
a radiator matrix assembly prepared using a parts fabrication process;
a lumen matrix component prepared using the parts fabrication process;
a connection component to attach the lumen matrix component to the radiator matrix assembly to create an assembled radiator matrix with molding space; and
an input foramen providing access to the molding space and enabling injection of liquid silicone into the assembled radiator matrix.

12. The apparatus of claim 11 wherein the parts fabrication process is a process selected from a group consisting of: a three-dimensional (3D) printing process, a mold preparation process, and a milling process.

13. The apparatus of claim 11 further including air vent openings in the assembled radiator matrix to remove air bubbles.

14. The apparatus of claim 11 wherein the molding space enabling formation of a cold-formed, one-piece, flexible, parallel-connection radiator or heat sink within the apparatus after injection of liquid silicone into the assembled radiator matrix.

15. The apparatus of claim 11 wherein the radiator matrix assembly includes first and second radiator matrix components configured to receive the lumen matrix component.

16. The apparatus of claim 11 wherein the radiator matrix assembly includes a snap housing and mounting flap matrix.

18. A cold-formed, one-piece, flexible, parallel-connection silicone radiator or heat sink comprising:
a plurality of parallel lumina fabricated from cured liquid silicone, the lumina of the silicone radiator configured for the transfer of cooling liquid therein; and
a liquid pump input and a liquid pump output fabricated on the plurality of parallel lumina enabling entry and exit of the cooling liquid to and from the silicone radiator.

19. The cold-formed, one-piece, flexible, parallel-connection silicone radiator or heat sink of claim 18 further including a connector for connecting the silicone radiator to a cooling hub.

20. The cold-formed, one-piece, flexible, parallel-connection silicone radiator or heat sink of claim 18 further including connectors for connecting a plurality of silicone radiators together and configured to enable cooling fluid to flow between the connected silicone radiators.
